(19) United States
(12) Patent Application Publication
(10) Pub. No.: US 2007/0034524 A1
(43) Pub. Date: Feb. 15, 2007

(54) Masking techniques for electrochemical stripping

(75) Inventors: Curtis Heath Riewe, Manchester, CT (US); Brian J. Griffith, Vernon, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION

(21) Appl. No.: 11/203,055

(22) Filed: Aug. 12, 2005

(51) Int. Cl. B23H 9/00; B23P 17/00

(52) U.S. Cl. 205/640; 29/888

(57) ABSTRACT

A maskant for use in an electrochemical stripping operation is provided. The maskant comprises an electrically conductive member, preferably one formed from a titanium based material, placed about a trailing edge of an airfoil portion of a turbine engine component. A method for removing a coating from a turbine engine component is also provided. The method comprises the steps of placing a maskant formed from an electrically conductive material, preferably a titanium based material, adjacent a trailing edge of an airfoil portion of the component, immersing the turbine engine component and the maskant into a bath, and electrochemically stripping the coating from unmasked portions of the turbine engine component.

### BACKGROUND OF THE INVENTION

The present invention relates to an improved technique for masking airfoils during electrochemical stripping operations.

It has been found that wall thinning of an airfoil portion of a turbine engine component will occur as a result of removing a coating applied to the airfoil portion and/or a diffusion layer formed on the airfoil portion using electrochemical stripping techniques. Wall thinning is highly undesirable because it leads to bending.

Thus, it is deemed desirable to mask the trailing edges of airfoils used in turbine engine components, such as vanes and blades, to prevent wall thinning and cooling hole closure caused by bending a thin wall. Many of the techniques employed today use non-conductive trailing edge maskants to prevent this from occurring. Typically, barrier types of maskants, such as plater's tape, lacquer, and UV-curable materials, have been used in the stripping processes.

Some of the maskants which have been used have caused trenching of the airfoil portion under the masked area. The trench is caused by crevice corrosion and is an unacceptable condition. It is speculated that the trench is formed as a result of a crevice being formed under the maskant as the coating and/or diffusion layer are removed. After the crevice is formed, crevice corrosion begins and propagates, causing the formation of the trench.

There is a need for improved maskant materials, particularly those which help avoid trenching.

### SUMMARY OF THE INVENTION

Accordingly, it is an object of the present invention to provide an improved maskant for use in electrochemical stripping operations.

It is a further object of the present invention to provide a maskant as above which avoids trenching.

The foregoing objects are attained by the maskant of the present invention.

In accordance with the present invention, a maskant for use in an electrochemical stripping operation is provided. The maskant broadly comprises a bead of ultra violet (UV) curable maskant placed along a trailing edge of an airfoil portion of a turbine engine component covering any trailing edge windows (openings) and a clip formed from an electrically conductive material, such as a titanium based material, to prevent crevice corrosion under the masking line.

The present invention also relates to a method for removing a coating from a turbine engine component. The method broadly comprises the steps of placing a UV curable maskant along a trailing edge of an airfoil portion of the component, placing a clip formed from an electrically conductive material, such as a titanium based material, over said UV curable maskant, immersing the turbine engine component with the UV curable maskant and clip into a bath, and electrochemically stripping the coating from unmasked portions of the turbine engine component.

Other details of the masking techniques for electrochemical stripping, as well as other objects and advantages attendant thereto, are set forth in the following detailed description and the accompanying drawings wherein like reference numerals depict like elements.

### BRIEF DESCRIPTION OF THE DRAWINGS

FIG. 1 illustrates a trailing edge portion of a turbine engine component having windows;

FIG. 2 illustrates the application of a UV curable maskant to the trailing edge;

FIG. 3 is a schematic representation of a first embodiment of a maskant in accordance with the present invention;

FIG. 4 is a schematic representation of a clip in accordance with the present invention; and

FIGS. 5-7 illustrate an alternative embodiment of a clip in accordance with the present invention.

### DETAILED DESCRIPTION OF THE PREFERRED EMBODIMENT(S)

As discussed above, the present invention relates to a masking technique for use in a method for electrochemically stripping coatings and/or diffusion layers from airfoil portions of turbine engine components, such as turbine blades, vanes, seals and shrouds. In one embodiment, the maskant for the trailing edge of the airfoil portion comprises a layer of a UV curable maskant material and a clip placed over the UV curable maskant formed from an electrically conductive material. Preferably, the electrically conductive material is formed from a titanium based material. Titanium is a preferred material because it will not corrode in many of the baths used in electrochemical stripping techniques. Root portions of the turbine engine component may be masked by dipping the root portions into a thin paint or by applying a lacquer in order to prevent any slight etching or pitting. In another embodiment, the maskant solely comprises a clip placed over the airfoil trailing edge.

The masking technique of the present invention may be used in conjunction with any suitable electrochemical stripping technique known in the art.

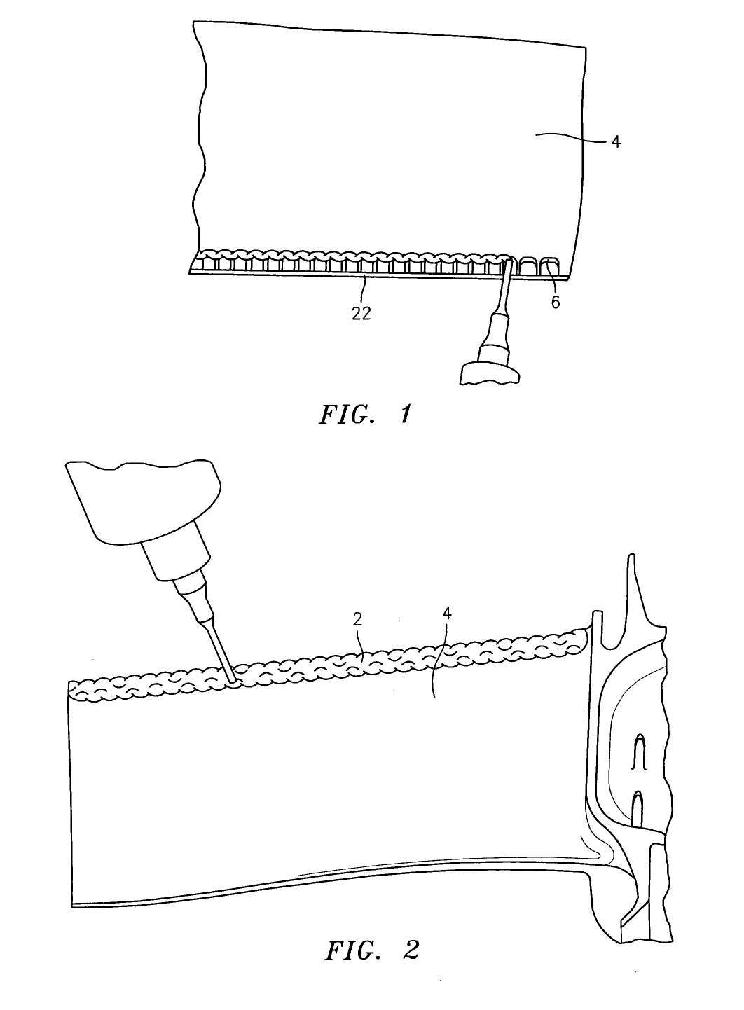

Referring now to FIG. 1, a trailing edge portion 22 of an airfoil portion 4 is shown. The trailing edge portion 22 has a plurality of windows or openings 6 which need to be protected during the electrochemical stripping technique.

In accordance with the present invention, as shown in FIG. 2, a UV curable maskant 2, such as DYMAX UV MASKANT-29605, is placed on the trailing edge portion 22 of an airfoil portion 4 of a turbine engine component, such as a turbine blade or vane. The UV curable maskant 2 preferably covers any trailing edge windows 6. The coverage of the UV curable maskant is dependent on part configuration. It is important that the UV maskant be applied so that a clip 30 may be placed on top of it. Typically, the UV curable maskant will cover up to 0.2 inches from the trailing edge on the concave side. After being applied, the maskant 2 is cured in a UV oven and checked for completeness of coverage. Thereafter, an electrically conductive member 10, preferably formed from a titanium based material, is placed over the maskant 2 on the trailing edge portion 22 of the airfoil 4. It has been found that the use of an electrically conductive member 10, such as one formed from a titanium based material, helps prevent the masked area from being completely stripped and helps prevent crevice corrosion, and thus trenching, from occurring. This is because the electrically conductive member 10 acts as a current thief or current shield which prevents the coating material and/or diffusion layer beneath the maskant from being removed.

Using the masking technique of the present invention, it is possible to obtain a coating remaining on the airfoil portion trailing edge of the turbine engine component which has a smooth transition between the fully stripped base alloy forming the turbine engine component and the fully protected coating. A smooth transition is desirable because it significantly reduces or eliminates any subsequent blending of the coating needed to remove any sharp corner.

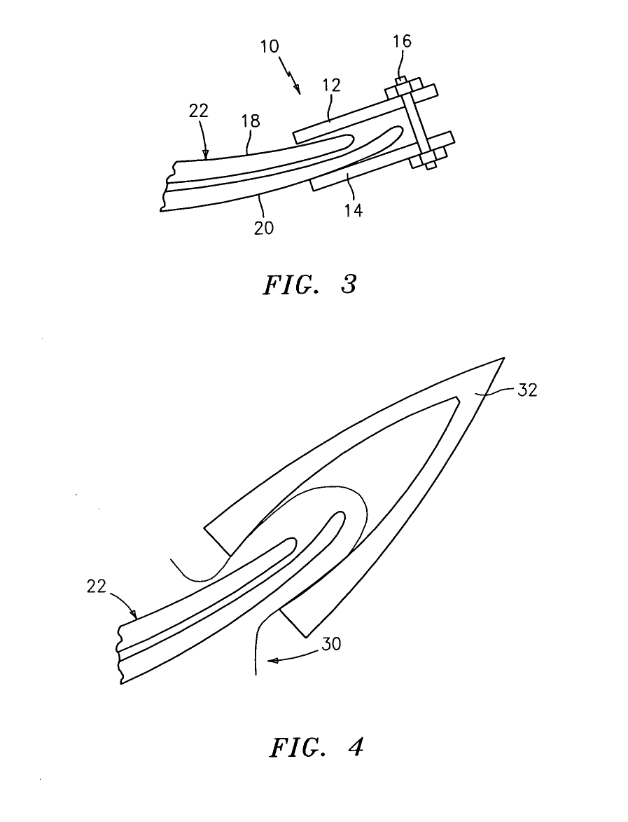

As shown in FIG. 3, the electrically conductive member 10 may comprise two bars 12 and 14 of a titanium based material bolted together via a bolt 16 and placed over opposed surfaces 18 and 20 of the trailing edge 22 having the UV curable maskant 2 applied thereto. Alternatively, as shown in FIG. 4, the member 10 may comprise a titanium foil member or clip 30 held onto the trailing edge 22 of the airfoil portion of the turbine engine component by one or more securing elements 32 or by friction. The securing elements 32 may be formed from any conductive material that does not corrode. A preferred material for each element 32 is titanium. When a titanium clip 30 is used, the member 30 may have a thickness in the range of from 0.020 to 0.030 inches.

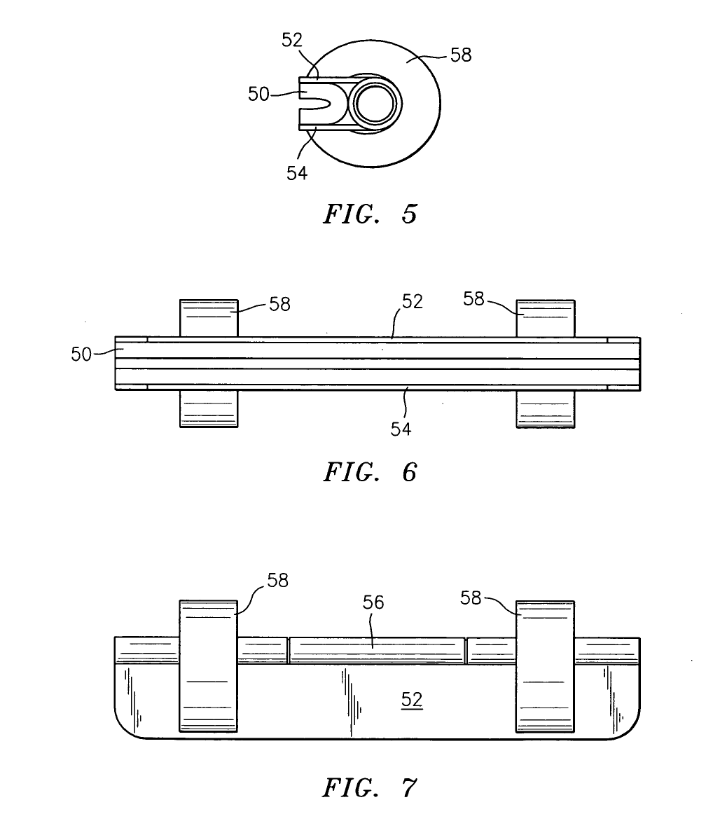

FIGS. 5-7 illustrate a preferred configuration for the clip 30 which can be used without any UV maskant. As can be seen, the clip 30 has a folded over piece 50 of an insulating material such as silicon rubber. The piece 50 conforms to the part and continues to seal the part as the coating is stripped away under it. This reduces the tendency to form trenches. On top of the insulating material piece are layers 52 and 54 formed from an electrically conductive material such as a titanium based material. The two layers 52 and 54 are joined to each other by a hinge structure 56. The hinge structure 56 allows the layers 52 and 54 to move relative to each other. When the clip 30 is placed over the trailing edge 22 of the airfoil portion of the turbine engine component, one or more variable positionable C-shaped securing member 58 may be placed over the layers 52 and 54. If desired, the securing members 58 may be formed from a plastic material. Still further, if desired, a UV curable maskant may be used under the clip 30.

Prior to, or subsequent to, applying the electrically conductive member 10 or clip 30, root portions of the turbine engine component may be masked to prevent any slight etching or pitting. Masking of the root portions may be achieved by dipping them into a thin paint, such as DYKEM layout ink fluid, or by hand applying a maskant, such as a suitable lacquer. Preferably, two coats of the root portion masking material should be applied. After application of the root portion masking material, the turbine engine component may be subjected to a drying treatment which depends upon the nature of the root portion maskant.

As previously mentioned, the use of an electrically conductive member 10 or clip 30, particularly one formed from a titanium based material, helps prevent trenching. It also provides a smoother transition between the coating on the trailing edge portion of the turbine engine component and the underlying substrate.

### EXAMPLE

Two high pressure turbine blades were stripped in a 4.7 vol. % hydrochloric acid solution at a temperature of approximately 20° C. The stripping potential set point was 0.08v with respect to an Ag/AgCl reference electrode. The turbine blades were stripped for 2 hours, water pressure sprayed, tripped for an additional two hours, burnt out, grit blasted, and heat tinted. All of the blades were masked at the root and the tip with Dymax X-391-17A. One of the blades had a U-channel mask in accordance with the present invention applied to the trailing edge. The other of the blades had a hinged clip in accordance with the present invention applied to the trailing edge. The test showed an absence of crevice corrosion at the trailing edge.

While the masking technique of the present invention preferably applies a UV curable material over the trailing edge portion, for removing certain coatings from some turbine engine components, the UV curable material may be omitted.

While the UV curable material may be applied to both sides of the trailing edge portion of the turbine engine component, it may also be applied to just one side such as the concave side.

After the trailing edge portions of the root portion have been masked, the turbine engine component is immersed in an acidic bath. The bath may be any suitable stripping bath known in the art. After immersion, the coating on the turbine engine component may be stripped using any suitable electromechanical stripping technique known in the art. The particular electrochemical stripping technique does not form part of the present invention.

While the present invention has been described with the maskant placed about a trailing edge of an airfoil portion of a turbine engine component, the maskant could also be applied to a leading edge or a tip of the airfoil portion and/or to a platform portion of the component.

It is apparent that there has been provided in accordance with the present invention masking techniques for electrochemical stripping which fully satisfy the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A maskant for use in an electrochemical stripping operation comprising an electrically conductive maskant placed about an edge of an airfoil portion of a turbine engine component.

2. A maskant according to claim 1, wherein said maskant is formed from a titanium based material.

3. A maskant according to claim 2, wherein said maskant comprises two bars of said titanium based material placed on opposite sides of said trailing edge and bolted together.

4. A maskant according to claim 2, wherein said maskant comprises a clip formed from a titanium based material placed over said trailing edge portion.

5. A maskant according to claim 2, wherein said maskant comprises a clip having a layer of insulating material and a pair of spaced apart plates placed over said insulating material layer, and wherein said plates are connected to each other by a hinge.

6. A maskant according to claim 5, wherein said plates are each formed from a titanium based material.

7. A maskant according to claim 5, further comprising at least one C-shaped securing member positioned over said plates.

8. A method for removing a coating from an airfoil portion of a turbine engine component comprising:
placing a maskant formed from an electrically conductive material on opposed sides of an edge of said airfoil portion;
immersing said turbine engine component with said maskant into a bath; and
electrochemically stripping a coating from unmasked portions of said turbine engine component.

9. A method according to claim 8, further comprising applying a UV curable material to at least one side of said trailing edge prior to said maskant placing step and placing said maskant over said UV curable material.

10. A method according to claim 8, wherein said maskant placing step comprises placing a maskant formed from a titanium based material on opposed sides of said trailing edge.

11. A method according to claim 8, wherein said maskant placing step comprises placing two bars formed from a titanium based material on opposed sides of said trailing edge and bolting said bars together.

12. A method according to claim 8, wherein said maskant placing step comprises placing a clip formed from a titanium based material on opposed sides of said trailing edge and securing said clip to said trailing edge.

13. A method according to claim 8, wherein said maskant placing step comprises placing a clip having a layer of insulating material and a pair of plates each formed from a titanium based material on opposed sides of the trailing edge and securing said clip to said trailing edge.

14. A method according to claim 8, further comprising placing a maskant on root portions of said turbine engine component.

15. A method according to claim 14, wherein said root portion masking step comprises applying a masking paint.

16. A method according to claim 14, wherein said root portion masking step comprises applying a lacquer to said root portions.

17. A system for masking a portion of a turbine engine component during an electrochemical strip operation, said system comprising:
a UV curable material placed on an edge portion of said turbine engine component; and
an electrically conductive member placed over said UV curable material.

18. The system according to claim 17, wherein said electrically conductive member is formed from a titanium based material.

19. The system according to claim 18, wherein said electrically conductive member comprises two bars of a titanium based material placed in opposite sides of said trailing edge.

20. The system according to claim 18, wherein said electrically conducive member comprises a clip formed from a titanium based material placed over said trailing edge portion.

21. The system according to claim 17, further comprising means for masking root portions of said turbine engine component.

22. The system according to claim 21, wherein said masking means comprises paint applied to said root portions.

23. The system according to claim 21, wherein said masking means comprises lacquer applied to said root portions.
